(19) United States
(12) Patent Application Publication
(10) Pub. No.: US 2018/0187802 A1
(43) Pub. Date: Jul. 5, 2018

(54) MULTI-LAYER PIPES

(71) Applicant: Polyflow LLC, Midland, TX (US)

(72) Inventors: James R. Copeland, Midland, TX (US); Liang Yu, Katy, TX (US)

(73) Assignee: Polyflow LLC, Midland, TX (US)

(21) Appl. No.: 15/858,323

(22) Filed: Dec. 29, 2017

Related U.S. Application Data
(60) Provisional application No. 62/440,942, filed on Dec. 30, 2016.

(51) Int. Cl. F16L 11/12; B32B 1/08; B32B 27/32; B32B 27/34; B32B 7/12; B32B 15/088; B32B 15/085; E21B 17/20

(52) U.S. Cl. CPC F16L 11/12; B32B 1/08; B32B 27/32; B32B 27/34; B32B 7/12; B32B 15/088; B32B 2323/043; E21B 17/20; B32B 2597/00; B32B 2250/04; B32B 2307/542; B32B 2377/00; B32B 15/085

(57) ABSTRACT

A method of manufacturing a flexible pipe that may include directing a first polymer composition through a first manifold and directing the first polymer composition along an outer surface of a metal tubular structure to form a first polymer tubular structure having an outer surface. Additionally, the method may include directing a second polymer composition through a second manifold and directing the second polymer composition onto the outer surface of first polymer tubular structure to form a second polymer tubular structure having an outer surface polymer tubular structure. Further, directing a third polymer composition through a third manifold and directing the third polymer composition onto the outer surface of second polymer tubular structure to form the flexible pipe. The flexible pipe includes a first layer made of the first polymer composition, a second layer made of the second polymer composition, and a third layer made of the third polymer composition.

### CROSS-REFERENCE TO RELATED APPLICATIONS

This application claims benefit, under 35 U.S.C. § 119, of U.S. Provisional Application Ser. No. 62/440,942 filed on Dec. 30, 2016 and entitled “Multi-layer Pipes.” The disclosure of this U.S. Provisional Application is incorporated herein by reference in its entirety.

### BACKGROUND OF DISCLOSURE

### Field of the Disclosure

The present disclosure relates to flexible pipe for conveying petroleum or other fluids offshore or on land.

### Background Art

Reinforced pipe is used to transport production fluids, such as oil and/or gas and/or water, from one location to another. The reinforced pipe is particularly useful in onshore static applications. The reinforced pipe is typically formed as an assembly of layered materials that form a fluid and pressure-containing conduit. The multi-layer structure of the reinforced pipe may include a thermoplastic internal fluid barrier, one or more reinforcement layer and a cover layer. The reinforced pipe used in static onshore applications may not be suitable for dynamic downhole applications due to the addition of external pressure loads. Additionally, the reinforced pipes used in these applications have radii of curvature greater than 20 times the outside diameter (OD) of the pipe.

A primary conduit through which reservoir fluids are produced to surface is called a production tube or production string. The production string is typically assembled with tubing and completion components in a configuration that suits the wellbore conditions and the production method. An important function of the production string is to protect the primary wellbore tubulars, including the casing and liner, from corrosion or erosion by the reservoir fluid. Due to the highly-corrosive nature of oil and natural gas, and the inherently harsh subterranean conditions deep within the well, the production tube must be made of a material having high corrosion resistance. Due to the high pressure of the fluids contained in the well, and the excessive weight of extreme lengths of the production tube, the production tube must also be made of a material having high strength. Therefore, it would be desirable to provide a production tube having good corrosion resistance and good tensile and radial strength. As such, in conventional methods, production tubes are typically made from a metal or metallic material. Additionally, the production tube connects the rig surface equipment with the production zone of the wellbore. Furthermore, metal production tubes are very heavy and awkward to handle, making the installation and operation of the metal production tube both cumbersome and dangerous. The extreme weight of metal production tube produces large friction forces when the tube is rotated about an axis off vertical, such as when the plurality of tubes is being torqued together or traveling through a horizontal bore. The friction forces induce excessive wear of the articulated tube and thus damage the production tube, casing, and wellbore.

### SUMMARY OF DISCLOSURE

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, this disclosure relates to a method of manufacturing a flexible pipe that may include directing a first polymer composition through a first manifold; directing the first polymer composition along an outer surface of a metal tubular structure; forming a first polymer tubular structure having an outer surface; directing a second polymer composition through a second manifold; directing the second polymer composition onto the outer surface of first polymer tubular structure to form a second polymer tubular structure having an outer surface polymer tubular structure; directing a third polymer composition through a third manifold; directing the third polymer composition onto the outer surface of second polymer tubular structure; forming the flexible pipe, wherein the flexible pipe includes a first layer made of the first polymer composition, a second layer made of the second polymer composition, and a third layer made of the third polymer composition.

In another aspect, this disclosure relates to a flexible pipe that may include a tube, the tube having a first end and a second end spaced axially from the first end, wherein the tube is a metal tubular structure with a fluid conduit; and a plurality of layers bonded on the metal tubular structure, the plurality of layers including an innermost layer made of a first polymer composition, a middle layer made of a second polymer composition, and an outermost layer made of a third polymer composition.

In another aspect, this disclosure relates to a method for making a flexible pipe, comprising (a) directing a first polymer composition through a first manifold, e.g., a solid structure having internal conduits through which a melted polymer composition is capable of passing; (b) directing the first polymer composition along one or more grooves in the outer surface of a metal tubular structure, e.g., a spiral mandrel distributor; and (c) forming the flexible pipe that includes the first polymer composition.

In another aspect, this disclosure relates to a method for making a flexible pipe, comprising: (a) directing a first polymer composition through a first manifold, e.g., a solid structure having internal conduits through which a melted polymer composition is capable of passing; (b) directing the first polymer composition along one or more grooves in the outer surface of a metal tubular structure, e.g., a spiral mandrel distributor; (c) forming a first polymer tubular structure having an outer surface; (d) directing a second polymer composition through a second manifold, e.g., a solid structure having internal conduits through which a melted polymer composition is capable of passing; (e) directing the second polymer composition onto the outer surface of the first polymer tubular structure to form a second polymer tubular structure having an outer surface; (f) directing a third polymer composition through a third manifold, e.g., a solid structure having internal conduits through which a melted polymer composition is capable of passing; (g) directing the third polymer composition onto the outer surface of the second polymer tubular structure; and (h) forming the flexible pipe that includes a first layer comprising the first polymer composition, a second layer comprising the second polymer composition, and the third layer comprising the third polymer composition, wherein the first and the third layer are bonded together by the second layer exhibiting a peel strength of at least about 14 lb_{f}/inch at 180° F., or 16 lb_{f}/inch at 180° F., or 18 lb_{f}/inch at 180° F., or 20 lb_{f}/inch at 180° F., and in some embodiments more than 20 lb_{f}/inch at 180° F. The bonding between the first and the third layer by the second layer may also have blistering resistance to oil and gas transportation at up to 3000 psig, 180° F., when periodical depressurizations are required.

In another aspect, this disclosure relates to a method for making a flexible pipe, comprising: (a) directing a first polymer composition comprising nylon through a first manifold, e.g., a solid structure having internal conduits through which a melted polymer composition is capable of passing; (b) directing the first polymer composition along one or more grooves in the outer surface of a metal tubular structure, e.g., a spiral mandrel distributor; (c) forming a first polymer tubular structure having an outer surface; (d) directing a second polymer composition comprising an adhesive polymer comprising polyethylene with maleic anhydride functional groups through a second manifold, e.g., a solid structure having internal conduits through which a melted polymer composition is capable of passing; (e) directing the second polymer composition onto the outer surface of the first polymer tubular structure to form a second polymer tubular structure having an outer surface; (f) directing a third polymer composition comprising high density polyethylene through a third manifold, e.g., a solid structure having internal conduits through which a melted polymer composition is capable of passing; (g) directing the third polymer composition onto the outer surface of the second polymer tubular structure; and (h) forming the flexible pipe that includes a first layer comprising the first polymer composition, a second layer comprising the second polymer composition, and the third layer comprising the third polymer composition. The maleic anhydride functional groups in the second polymer composition may form chemical bonds, e.g., covalent bonds, with both the nylon molecules in the first polymer composition and the high density polyethylene in the third polymer composition, thus providing greater peel strength under the high temperatures specified herein as compared to a composition lacking the maleic anhydride functional groups or the maleic anhydride functional groups being carried by a low or medium density polyethylene.

In any of methods disclosed herein, the directing of a first polymer composition through a first manifold can include: (a) directing the first polymer composition in the form of a primary stream to the manifold; (b) splitting the primary stream into two or more secondary streams; and (c) directing each of the two or more secondary streams toward the one or more grooves in the outer surface of the metal tubular structure.

In any of methods disclosed herein, any two or more secondary streams can include a first secondary stream and a second secondary stream in which the method can additionally comprise: (a) directing the first secondary stream circumferentially through a first conduit; and (b) directing the second secondary stream circumferentially through a second conduit, wherein the first conduit and the second conduit each has an entry point and an exit point and each has substantially the same diameter and flow path distance from the entry point to the exit point of each conduit.

In any of methods disclosed herein, the directing of a first polymer composition through a first manifold can include: (a) directing the first polymer composition in the form of a primary stream to the manifold; (b) splitting the primary stream into two or more secondary streams; (c) splitting each of the two or more secondary streams into two or more tertiary streams; and (d) directing each of the two or more tertiary streams toward the one or more grooves in the outer surface of the metal tubular structure.

In any of methods disclosed herein, any two or more secondary streams can include a first secondary stream and a second secondary stream, and any two or more tertiary streams can include a first tertiary stream and a second tertiary stream, in which such a method can additionally comprise: (a) directing the first secondary stream circumferentially through a first large conduit; (b) directing the second secondary stream circumferentially through a second large conduit; (c) directing the first tertiary stream circumferentially through a first small conduit; and (d) directing the second tertiary stream circumferentially through a second small conduit, wherein the first large conduit and the second large conduit each has a larger diameter than the first small conduit and the second small conduit.

In any of methods disclosed herein, any directing of a first polymer composition through a first manifold can include directing a stream of the first polymer composition within the first manifold so that the first polymer composition enters one or more grooves in either a clockwise or counterclockwise circumferential direction from the manifold.

In any of methods disclosed herein, any directing of a first polymer composition through a first manifold can include directing a stream of the first polymer composition within the manifold so that the first polymer composition enters one or more grooves in a substantially radial direction, or in a substantially circumferential direction.

In any of methods disclosed herein, the metal tubular structure can have a first end and a second end, wherein the first end may have has a larger diameter than the second end.

In any of methods disclosed herein, one or more grooves include grooves that extend along at least part of the length of the metal tubular structure and that are arranged in a spiral (or helical) configuration.

In any of methods disclosed herein, one or more grooves can include at least one groove that: (a) extends along at least part of the length of the metal tubular structure; (b) is arranged in a spiral configuration; and (c) has a diminishing depth, such that the groove is deeper at a point where the first polymer composition enters the groove than at the point where the first polymer composition exits the groove.

In any of methods disclosed herein, one or more grooves can include at least two grooves extending along at least part of the length of the metal tubular structure and such at least two grooves are parallel with one another.

In any of methods disclosed herein, can include the steps of (a) directing a second polymer composition through a second manifold; (b) directing the second polymer composition onto the outer surface of the first polymer tubular structure; and (c) forming the tubular liner that includes a first layer comprising the first polymer composition and a second layer comprising the second polymer composition.

In any of methods disclosed herein can additionally comprise: (a) directing a third polymer composition through a third manifold; (b) directing the third polymer composition onto the outer surface of the second polymer tubular structure; and (c) the tubular liner that includes a first layer comprising the first polymer composition; a second layer comprising the second polymer composition; and a third layer comprising the third polymer composition.

Other aspects and advantages will be apparent from the following description and the appended claims.

### DETAILED DESCRIPTION

The following is directed to various embodiments of the disclosure. Although one or more of these embodiments may be preferred, the embodiments disclosed should not be interpreted, or otherwise used, as limiting the scope of the disclosure, including the claims. In addition, those having ordinary skill in the art will appreciate that the following description has broad application, and the discussion of any embodiment is meant only to be exemplary of that embodiment, and not intended to suggest that the scope of the disclosure, including the claims, is limited to that embodiment.

References herein to terms such as “inner” or “interior” and “outer” or “exterior” refer, respectively, to directions toward and away from the center of the referenced element, and the terms “radial” and “axial” refer, respectively, to directions perpendicular and parallel to the longitudinal central axis of the referenced element are made by way of example, and not by way of limitation, to establish a frame of reference. It is understood that various other reference frames may be employed for describing the invention.

In the following discussion and in the claims, the terms “including” and “comprising” are used in an open-ended fashion, and thus should be interpreted to mean “including, but not limited to . . . .” Also, the terms “disposed,” “attached,” “couple,” or “couples” are intended to mean either an indirect or direct connection. For example, if a first component is coupled to a second component, that connection may be through a direct connection, or through an indirect connection via other components, devices, and connections.

Further, embodiments disclosed herein are described with terms designating orientation in reference to a vertical wellbore, but any terms designating orientation should not be deemed to limit the scope of the disclosure. For example, embodiments of the disclosure may be made with reference to a horizontal wellbore. It is to be further understood that the various embodiments described herein may be used in various orientations, such as inclined, inverted, horizontal, vertical, etc., and in other environments, such as sub-sea, without departing from the scope of the present disclosure. The embodiments are described merely as examples of useful applications, which are not limited to any specific details of the embodiments herein.

In one aspect, embodiments herein disclose a multi-layered pipe that provides a path for conducting fluids (i.e., liquids and gases) along the length of the multi-layered pipe. For example, the multi-layered pipe can transmit fluids down a well hole for operations upon the interior surfaces of the well hole, the multi-layered pipe can transmit fluids or gases to hydraulic or pneumatic machines operably coupled to the multi-layered pipe, and/or the multi-layered pipe can be used to transmit fluids on surface from well holes to transmission or distribution pipelines. In some embodiments, the multi-layered pipe may be used to rehabilitate corroded casing in the wellbore and serve as a production string. In such an application, a gas lift may be required to improve production of the well. The gas lift includes injecting gas in the annulus between the multi-layered pipe and the casing while production fluid flows in the conduit of the multi-layered pipe. Additionally, the injected gas pressure is higher than the production fluid pressure to result in a net external pressure on the multi-layered pipe. Further, the multi-layered pipe may be used a velocity string. The velocity string is a small tube, usually 1 inch to 3½ inches in diameter that is placed into a production tubing to increase the flow velocity to the critical velocity needed to lift liquids from the well. Furthermore, one skilled in the art will appreciate how the multi-layered pipe is not limited to a specific diameter size and may be any size required for use.

As described above, the multi-layered pipe can be used in various applications. Additionally, various methods and devices have been proposed and utilized for making multi-layered pipes. For example, in conventional methods, the multi-layered pipe may be made from a seamless pipe manufacturing, a welded pipes manufacturing, or an extrusion pipe manufacturing. However, the conventional methods and devices lack all the steps or features of the methods and/or devices for manufacturing the multi-layered pipe as will be described below. Specifically, the use of a multi-layer pipe head to manufacture a multi-layered pipe is presented below. Furthermore, it is contemplated that the methods and devices covered by using the multi-layer pipe head for manufacturing the multi-layered pipe may solve many of the problems that prior art methods and devices have failed to solve. Also, it is contemplated that using the multi-layer pipe head for manufacturing the multi-layered pipe may have benefits that could be surprising and unexpected to a person of ordinary skill in the art.

A multi-layer pipe head which may be provided with an upper left (upstream) portion, an upper right (downstream) portion, a lower left (upstream) portion, and a lower right (downstream) portion. Additionally, the multi-layer pipe head may have a mandrel. In some embodiments, the multi-layer pipe head can include a plurality of head segments and each of the head segments may include a manifold. The manifold includes one or more conduits through which any liquid or fluid may flow. For example, the fluid may be a melted polymer/thermoplastic such as nylon, polyolefin, or polyethylene. Generally, as noted elsewhere herein, the multi-layer pipe head may be any pipe head that has at minimum a manifold and a grooved tubular structure, also referred to as a spiral flow distributor, for directing the flow of melted polymer and at least one mandrel for supporting the multi-layer product (i.e., pipe) being formed. As noted above, the manifold is may be a solid structure having internal conduits through which a melted polymer composition is capable of passing. Further, the spiral flow distributor may also be referred to as a “spiral mandrel distributor” hereinafter. One skilled in the art will appreciate how the pipe head may or may not include the other structural components (also, “structures” or “components”) discussed herein, but in some embodiments includes at least those components. For example, the multi-layer pipe head may include internal heaters (i.e., coil heater with built in thermocouple) and coolers that are used to maintain a temperature of the melted materials flowing therein.

In some embodiments, the multi-layer pipe head may have three manifolds for applying different layers of a multi-layer pipe. For example, the three manifolds may apply an inner nylon layer, a middle high density polyethylene (“HDPE”) “tie” or adhesive layer, and an outer HDPE layer, with the understanding that the terms “inner,” “middle,” and “outer” refer to where the layers are relative to each other and that other layers may be formed at any position relative to those three layers. In at least one embodiment, a first manifold feeds melted nylon polymer into grooves of a first spiral melt flow distributor. A second manifold feeds melted HPDE adhesive directly onto an outside surface of the just-formed nylon tubular polymer. A third manifold feeds melted HDPE into the grooves of a second spiral melt flow distributor, in the same way the first manifold feeds melted nylon polymer into the grooves of the first spiral flow distributor. Then after the melted HDPE passes through the grooves of the second spiral melt flow distributor, the melted HDPE is fed directly onto an outside surface of the just-formed HDPE tie layer. Accordingly, a three-layer tubular product can be formed. Both the first spiral melt flow distributor and the second spiral melt flow distributor are positioned around a central fixed mandrel which can be a single piece that extends axially through the multi-layer pipe head. The central fixed mandrel is bolted to an end of the first spiral flow distributor, and an inside surface of the three-layer tubular is formed around a surface of the central fixed mandrel. Additionally, the first spiral melt flow distributor and the second spiral melt flow distributor are fixed and do not rotate. As such, the first spiral melt flow distributor and the second spiral melt flow distributor receive the melt stream from the manifolds and then direct the melt stream via grooves in a helical (also referred to as spiral) flow direction so that the melted material in the grooves eventually runs together and a tubular shape is formed.

As described above, the first layer is formed directly on the outer surface of the mandrel and the other layers (middle and outer) are formed on the outer surface of the first layer that is previously formed upstream. In contrast with the first manifold and third manifold which feed melted polymer into grooves in the different spiral melt flow distributors, the tie (adhesive) layer is fed from the second manifold to a very abbreviated set of shallow spiral grooves on the surface of first spiral melt flow distributor and to a very short mandrel section. Each individual head segment has a corresponding mandrel where the layer, in tubular shape, is formed and then subsequently joined with the previously formed flowing layers. One skilled in the art will appreciate how the multi-layer pipe head is made up of independent segments that can be operated to form one layer or, alternatively, many layers. Each subsequent layer builds on the previous layers and each layer's extrusion control parameters can be precisely controlled without affecting any other layer even when extruding plastics with broad ranges of parameters are used.

In one or more embodiments, the multi-layer pipe head may include individual head segments some of which are described in greater detail below. Each of the head segments includes a solid substantially cylindrical portion shaped to define an inner space such that, when the head segments are coupled together, the head segments are capable of fitting around the mandrel 6 whose outer surface supports the individual and combined cylindrical layers and pipe being formed. As an alternative to a single unitary mandrel, separate adjoining mandrels (or mandrel sections) can be used. Some of the head segments in the pipe head also include a manifold, as described below. It is further envisioned that the multi-layer pipe head can have a single mandrel or multiple mandrels. The term “mandrel” as used herein refers to any elongated cylindrical member positioned axially in a pipe head and may refer to a single unitary structure or multiple structures positioned end-to-end, which may also be referred to as “mandrel sections.”

A mandrel may include individual mandrel sections. The mandrel and each individual mandrel section may be cylindrical and have an outer surface and an inner surface. The mandrel should be made of metal (e.g., 4140 steel) with outer surfaces that may be polished and chromed. Additionally, non-flow surfaces of the mandrel are machine-finished and should be capable of conducting and maintaining heat at high temperatures, particularly along the outer surface of the mandrel, and may also maintain the heat in an evenly distributed manner. For example, the heat is evenly distributed to avoid “hot” or “cold” spots, which could have a deleterious effect on the final product. Additionally, one skilled in the art will appreciate how different mandrel sections may be maintained at different temperatures, when in the melted nylon is being fed into one of the head segments, the melted functionalized polyethylene is being fed into another head segment, and high density polyethylene is being fed into yet another head segment.

In some embodiments, the multi-layer pipe head may be thermally isolated into distinctly different and individual segments within the multi-layer pipe head. By the thermally isolating the multi-layer pipe head, plastic materials of widely different processing temperatures may be processed simultaneously in layers without detriment to adjacent layers of a material with a different processing temperature. Each segment may also have a different pressure. Additionally, the multi-layer pipe head can be used to maintain individual layer processing temperatures and pressures without mixing flow streams of individual layers whose temperatures and pressures are not the same. For example, plastics of higher processing temperatures will not affect adjacent flow stream melting temperatures during pipe formation. One skilled in art will appreciate how the multi-layer pipe head may also use internal heaters and coolers to maintain critical melt flow temperatures during formation of the pipe, and thus, avoiding a change or loss of flow due to improper flow surface temperatures.

The multi-layer pipe head includes multiple head segments, multiple groove tubular sections, and multiple mandrels, each coupled together so that each segment and section can be in physical contact with at least one adjoining segment or section. Additionally, each segment and section can be in separate pieces rather than necessarily forming a unitary structure. One skilled in the art will appreciate how each segment and section in separate pieces may allow the temperature and pressure of each head segment and corresponding tubular section to be controlled with substantial independence without being substantially influenced by the temperature of an adjoining segment or section. For example, the multi-layer pipe head can be operated so that a higher processing temperature used for one head segment will not have substantial influence on the processing temperature and pressure used for an adjoining head segment. Accordingly, for example purposes only, an operator can control the temperature of one head segment at a temperature of approximately 570° F., corresponding to the desired processing temperature for melted nylon being processed in that head segment. Simultaneously, the operator can control the temperature used for an adjoining head segment at a lower temperature (e.g., a temperature of approximately 520° F.), corresponding to the desired processing temperature for functionalized polyethylene. Similarly, an operator can control the temperature of yet another head segment independently of the temperature of the adjoining head segment that is immediately upstream thereof.

Each head segment may also include a corresponding inlet structure. For example, the melted material (e.g., nylon polymer) can enter the first head segment through a first inlet structure (i.e., first head inlet) which includes an open conduit passing the melted material to the first inlet structure. The open conduit extends from an inlet opening of the first inlet structure to an inlet exit of the first inlet structure, such that the first head segment feeds melted material into a manifold inlet of the first manifold. Additionally, the first inlet structure may include an outer inlet segment and an inner inlet segment. The inner inlet segment may be affixed to the first manifold by bolts or any other conventional manner. It is further envisioned that at least a portion of an inlet in the outer inlet segment includes an elbow so that a direction of the melted material may be changed as the melted material flows into the first head segment. Furthermore, one of the inlet segments of the first inlet structure may include a female seat into which a male protruding portion of another inlet segment of the first inlet structure can fit. For example, the inner inlet segment has a female seat for receiving a male protruding portion of the outer inlet segment, such that the outer inlet segment can be rotated during operation or it can be removed and exchanged for a different inlet segment (e.g., for cleaning or replacement). The melted material that enters the inlet opening from the outside of the first head segment, such as, from an extruder (not shown) that moves through the first inlet structure and then enters the manifold inlet of the first manifold. In operation, the melted material flows through various conduits in the first manifold, then into and along the grooves of the first spiral flow distributor, where the melted material flows downstream along a spiral flow-path and then forms a cylindrical shape.

As discussed above, the second head segment also includes a second inlet structure. The melted material, e.g., a functionalized high or low density polyethylene, enters the second head segment through the second inlet structure (i.e., second head inlet) which includes an open conduit passing through the second inlet structure. The open conduit extends from an inlet opening of the second inlet structure to an inlet exit of the second inlet structure, such that the open conduit feeds the melted material into a manifold inlet to the second manifold. One skilled in the art will appreciate how the melted material that enters the inlet opening from the outside of the second head segment, such as, from an extruder moves through the second inlet structure and then enters the manifold inlet of the second manifold. Additionally, the second inlet structure may be affixed to the second manifold by bolts. Similarly, the third head segment also includes a third inlet structure. The melted material, e.g., high-density polyethylene, enters the third head segment through the third inlet structure (i.e., head inlet) which includes an open conduit passing through the third inlet structure. The open conduit extending from an inlet opening of the third inlet structure to an inlet exit of the third inlet structure, such that the open conduit feeds the melted material into a manifold inlet to the third manifold. One skilled in the art will appreciate how the melted material that enters the inlet opening from the outside of the third head segment, such as, from an extruder moves through the third inlet structure and then enters the manifold inlet of the third manifold. Additionally, the third inlet structure may be affixed to the third manifold by bolts. In operation, the melted material flows through various conduits in the third manifold, then into and along the grooves of the second spiral flow distributor, where the melted material flows downstream along a spiral flow-path and then forms a cylindrical shape.

In one or more embodiments, the melted material, e.g., melted nylon, flows from the inlet exit of the inlet structure into the manifold inlet of the first manifold. From the manifold inlet, the conduit at a first fork splits into two streams. For example, a first stream exiting left from the first fork (i.e., a first split) flows through a first large conduit clockwise along a first circumferential arc. A second stream exiting right from the first fork (i.e., the first split) flows through a second large conduit counterclockwise along a second circumferential arc. Additionally, the first and second arcs have the same arc sizes, and the lengths of the first and second large conduits are the same, so that the distance the melted material flows is the same (where the length and distance refer to the non-linear distance of the flow-path of the melted material).

The first stream passing through the first large conduit splits at a second fork into two sub-streams defined by a third conduit and a fourth conduit which are smaller in diameter than either of the first large manifold conduits. Similarly, the second stream in the second large conduit splits at a third fork into two sub-streams defined by a fifth conduit and a sixth conduit which may also be smaller in diameter than either the first large conduit or the second large conduit. Furthermore, the fifth conduit and the sixth conduit may have the same diameter as the diameters of the third conduit and the fourth conduit. In operation, the melted material moves in the form of four sub-streams through the third, fourth, fifth and sixth small manifold conduits which may have substantially equal diameters. Said sub-streams leave exit ports of the small manifold conduits and make contact with a spiral melt flow distributor which is a cylindrical or tubular member having spiral (helical) grooves on a surface through which move the melted material in a net axial direction, from left to right.

In one more embodiments, the melted material, e.g., melted functionalized polyethylene, flows from the inlet exit of the inlet structure into the manifold inlet of the second manifold. From the manifold inlet, the conduit at a first fork splits into two streams. For example, a first stream exiting left from the first fork (i.e., a first split) flows through a first large conduit clockwise along a first circumferential arc. A second stream exiting right from the first fork (i.e., the first split) flows through a second large conduit counterclockwise along a second circumferential arc. Additionally, the first and second arcs have the same arc sizes, and the lengths of the first and second large conduits are the same, so that the distance the melted material flows is the same so that the distance the melted material flows until splitting is the same. In some embodiments, the first stream passing through the first large conduit is directed in a first quarter circle through a portion of the first large conduit that is first directed outwardly away from an axis of the second manifold and then curves back inwardly toward the axis of the second manifold. Additionally, from the first quarter circle, the first stream then splits at a second fork into two sub-streams defined by a third conduit and a fourth conduit which may or may not be smaller in diameter than either of the first large manifold conduits.

The second stream passing through the second large conduit in a counterclockwise direction is directed in a counterclockwise quarter circle through a portion of the second large conduit that is first directed outwardly away from the axis of the second manifold, then curves back inwardly toward the axis of the second manifold. Additionally, from the counterclockwise quarter circle, the second stream then splits at a third fork into two sub-streams defined by a fifth conduit and a sixth conduit which may or may not be smaller in diameter than either of the first large manifold conduits and may be the same diameter as the diameter of the third and fourth conduits. In operation, the melted material moves in the form of four sub streams through the third, fourth, fifth and sixth small manifold conduits that may have substantially equal diameters. Furthermore, after splitting left at the second fork, one of the sub-streams moves through small conduit in a clockwise direction, then curves back to a counterclockwise direction circumferentially around an inner surface of the second manifold for over a quarter of a revolution, such as substantially half of a revolution, then exits through a first exit port. Also, when splitting right at the second fork, the other of the sub-stream moves through the small conduit in a counterclockwise direction, then is directed toward the axis of the second manifold then turns to move circumferentially around the inner surface of the second manifold in a counterclockwise direction for over a quarter of a revolution, such as half of a revolution, then exits through a second exit port.

In one aspect, after splitting left at the third fork, one of the sub-streams moves through small conduit in a counterclockwise direction, then curves back to a clockwise direction where it proceeds circumferentially around the inner surface of the second manifold in a counterclockwise direction for over a quarter of a revolution, such as substantially half of a revolution, then exits through a third exit port. Similarly, after splitting right at third fork, the other of the sub-stream moves through small conduit in a counterclockwise direction, then is directed toward the axis of the second manifold then turns to move circumferentially around the inner surface of the second manifold in a counterclockwise direction for over a quarter of a revolution, such as half of a revolution, then exits through a fourth exit port. It is further environed that before leaving the second manifold, each of the sub-streams of the melted material are moving circumferentially in the same direction. For example, each of the sub-streams of the melted material exits counterclockwise at four circumferentially evenly spaced points around the spiral distributor at 0 degrees, 90 degrees, 180 degrees, and 270 degrees. The sub-streams leave the exit ports of the small manifold conduits and make contact with the spiral melt flow distributor in a tangential direction to the cylindrical or helical surface of the distributor and grooves. The spiral distributor is a cylindrical or tubular member having spiral grooves on a surface of the tubular member, which when rotated moves the melted material 17 in an axial direction, from the left to the right.

In one more embodiments, the melted material, e.g., melted high-density polyethylene, flows from the inlet exit of the inlet structure into the manifold inlet of the third manifold. From the manifold inlet, the conduit at a first fork splits into two streams. For example, a first stream exiting left from the first fork (i.e., a first split) flows through a first large conduit clockwise along a first circumferential arc. A second stream exiting right from the first fork (i.e., the first split) flows through a second large conduit counterclockwise along a second circumferential arc. Additionally, the first and second arcs have the same arc sizes, and the lengths of the first and second large conduits are the same, so that the distance the melted material flows is the same so that the distance the melted material flows until splitting is the same. The first stream passing through the first large conduit splits at a second fork into two sub-streams defined by a third conduit and a fourth conduit which are smaller in diameter than either of the first large manifold conduits.

Similarly, the second stream in the second large conduit splits at a third fork into two sub-streams defined by a fifth conduit and a sixth conduit which may also be smaller in diameter than either the first large conduit or the second large conduit. Furthermore, the fifth conduit and the sixth conduit may have the same diameter as the diameters of the third conduit and the fourth conduit. In operation, the melted material moves in the form of four sub-streams through the third, fourth, fifth and sixth small manifold conduits which may have substantially equal diameters. Said sub-streams leave exit ports of the small manifold conduits and make contact with a spiral melt flow distributor which is a cylindrical or tubular member having spiral (helical) grooves on a surface through which move the melted material in a net axial direction, from left to right.

As discussed elsewhere herein, the multi-layer pipe head may include two grooved tubular members also referred to as tubular structures, tubulars, spiral melt flow distributors, spiral distributors, and distributors. As discussed above, melted polymer may be dispensed from the first and third manifolds through the manifold exit ports to the distributors, so that the melted polymer streams enter the grooves formed along the surfaces of the distributors.

As discussed elsewhere herein, the diameter of the spiral distributor (i.e., the first spiral melt flow distributor and the second spiral melt flow distributor) may gradually become smaller as one moves along the length of the spiral distributor from the upstream part of the spiral distributor, to the downstream part of the spiral distributor. The grooves form a spiral along the outer surface along the length of the spiral distributor. However, each spiral distributor has four separate parallel grooves which spiral along the outer surface along the length of the spiral distributor. Any of the grooves may have a fixed width but varying depth along the length of the groove as it spirals around the outer surface of the spiral distributor. At the entrance to each groove, closest to where the melted polymer fed to the spiral distributor first contacts the groove, the depth of the groove may be the greatest (i.e., the deepest); however, at the exit from each groove, the depth of the groove is the least (i.e., the shallowest). In at least one embodiment, four grooves may be provided, each of which can have the same width as the other grooves. Each width does not vary as each groove extends in spiral format around the circumference of the spiral distributor and axially toward the downstream direction. Each groove is at its deepest at the entry point and shallowest at the exit point, where the depth of each groove gradually becomes zero, The spiral distributors may have apertures through which bolts are inserted, such that the first spiral inch flow distributor is affixed to the first manifold.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of manufacturing a flexible pipe, comprising:
directing a first polymer composition through a first manifold;
directing the first polymer composition along an outer surface of a metal tubular structure;
forming a first polymer tubular structure having an outer surface;
directing a second polymer composition through a second manifold;
directing the second polymer composition onto the outer surface of first polymer tubular structure to form a second polymer tubular structure having an outer surface;
directing a third polymer composition through a third manifold;
directing the third polymer composition onto the outer surface of the second polymer tubular structure;
forming the flexible pipe, wherein the flexible pipe comprises a first layer made of the first polymer composition, a second layer made of the second polymer composition, and a third layer made of the third polymer composition.

2. The method of claim 1, wherein the first polymer composition is made from a polymeric material selected from a polyamide, the second polymer composition is made from an adhesive polymer selected from a polyethylene with maleic anhydride functional groups, and the third polymer composition is made from an adhesive polymer selected from a high density polyethylene.

3. The method of claim 2, further comprising forming chemical bonds from the maleic anhydride functional groups in the second polymer composition with the polyamide in the first polymer composition and the high density polyethylene in the third polymer composition.

4. The method of claim 3, wherein the bonding comprises a peel strength of at least 14 lb_{f}/inch at 180° F. and a blistering resistance at or up to 3000 psig and 180° F.

5. The method of claim 1, further comprises:
directing the first polymer composition in the form of a primary stream within the first manifold,
splitting the primary stream into two or more secondary streams, and
directing each of the two or more secondary streams toward one or more grooves in the outer surface of a metal tubular structure.

6. The method of claim 5, further comprises:
directing a first secondary stream circumferentially through a first conduit within the first manifold and directing a second secondary stream circumferentially through a second conduit within the first manifold, and
wherein first conduit and the second conduit each has an entry point, an exit point, a same diameter, and flow path distance from the entry point to the exit point of each conduit.

7. The method of claim 6, wherein the first polymer composition enters the one or more grooves in a radial direction.

8. The method of claim 7, further comprising injecting the first polymer composition at an enter point in the one or more grooves and exiting the one or more grooves at an exit point, wherein a depth at the enter point is deeper than a depth at the exit point.

9. The method of claim 1, further comprises:
directing the first polymer composition in the form of a primary stream within the first manifold,
splitting the primary stream into two or more secondary streams,
splitting each of the two or more secondary streams into two or more tertiary streams, and
directing each of the two or more tertiary streams toward one or more grooves in the outer surface of a metal tubular structure.

10. The method of claim 9, further comprises:
directing a first secondary stream circumferentially through a first conduit within the first manifold and directing a second secondary stream circumferentially through a second conduit within the first manifold,
directing a first tertiary stream circumferentially through a third conduit within the first manifold and directing a second tertiary stream circumferentially through a fourth conduit within the first manifold, and
wherein a diameter of the first conduit and the second conduit is larger than a diameter of the third conduit and the fourth conduit.

11. The method of claim 10, wherein the first polymer composition enters the one or more grooves in a radial direction.

12. The method of claim 11, further comprising injecting the first polymer composition at an enter point in the one or more grooves and exiting the one or more grooves at an exit point, wherein a depth at the enter point is deeper than a depth at the exit point.

13. The method of claim 1, further comprising using a spiral flow distributor to direct the first polymer composition, the second polymer composition, and the third polymer composition.

14. A flexible pipe, comprising:
a tube, the tube having a first end and a second end spaced axially from the first end, wherein the tube is a metal tubular structure with a fluid conduit; and
a plurality of layers bonded on the metal tubular structure, the plurality of layers comprise an innermost layer made of a first polymer composition, a middle layer made of a second polymer composition, and an outermost layer made of a third polymer composition.

15. The flexible pipe of claim 14, wherein the first end has a large diameter than the second end.

16. The flexible pipe of claim 14, further comprising one or more grooves, arranged in a spiral or helical configuration, extending along at least a part of a length of the metal tubular structure.

17. The flexible pipe of claim 16, wherein the one or more grooves has a diminishing depth thereby the groove is deeper at a point wherein the first polymer composition enters the groove than at a point where the first polymer composition exits groove.

18. The flexible pipe of claim 14, wherein the first polymer composition is made from a polymeric material selected from a polyamide, the second polymer composition is made from an adhesive polymer selected from a polyethylene with maleic anhydride functional groups, and the third polymer composition is made from an adhesive polymer selected from a high density polyethylene.

19. The flexible pipe of claim 18, wherein the plurality of layers bonded together comprises a peel strength of at least 14 lb_{f}/inch at 180° F. and a blistering resistance at or up to 3000 psig and 180° F.

20. The flexible pipe of claim 14, wherein the metal tubular structure is a barrier of a fluid in the fluid conduit from the plurality of layers.
